(19) United States
(12) Patent Application Publication
(10) Pub. No.: US 2007/0021218 A1
(43) Pub. Date: Jan. 25, 2007

(54) Gaming machine

(75) Inventor: Kazuo Okada, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: ARUZE CORP., Tokyo (JP)

(21) Appl. No.: 11/484,860

(22) Filed: Jul. 12, 2006

(30) Foreign Application Priority Data
Jul. 19, 2005 (JP) 2005-208170

(51) Int. Cl. G06F 19/00

(52) U.S. Cl. 463/47

(57) ABSTRACT

A gaming machine comprises a display unit, a chair, and a guide unit. The display unit displays game information. The chair includes a seat and a backrest. The guide unit is connected to the chair, and capable of placing the chair in a sitting position which enables a player to sit on the seat and in a protecting position which makes the backrest protect the display unit by covering a front side of the display unit.

### CROSS REFERENCE TO RELATED APPLICATION

This application is based upon and claims the benefit of priority from the prior Japanese Patent Application No. 2005-208170, filed on Jul. 19, 2005, the entire contents of which are incorporated herein by reference.

### BACKGROUND OF THE INVENTION

1. Field of the Invention

The present invention relates to a gaming machine such as a slot machine, in which columns of symbols are variably displayed.

2. Description of Related Art

A slot machine is known as a gaming machine that pays out game media such as medals, coins, etc. (hereinafter called “coins”) in accordance with a game result. Slot machines are arrayed in a row, and further rows of them are arranged in parallel. Under a spatial condition in a game arcade, a passage between two rows of slot machines is generally narrow. Chairs are placed in the passage. Therefore, it is not very easy for a player to go through the passage.

Japanese Patent Unexamined Publication No. 6-63242 discloses a chair having a foldable backrest and capable of sliding toward a corresponding gaming machine in order to widen a passage. Japanese Patent Unexamined Publication No. 8-243251 discloses a chair that can be received in a storage space provided in a lower part of a gaming machine. Japanese Patent Unexamined Publication No. 10-216349 discloses a chair that is provided at an eccentric position of a turntable so that when the turntable rotates the chair can enter a storage space provided in a lower part of a gaming machine.

### SUMMARY OF THE INVENTION

Some players rage about losing games and badly attack gaming machines. In such a case, a part of the gaming machine which most particularly needs protection against the player's violence is a liquid crystal display. A liquid crystal display is expensive and an important part that displays an effect image and the like, but nevertheless it is defenselessly exposed because of its property and therefore likely to become a target of attack.

Thus, as a means for protecting a liquid crystal display, the present inventors have taken notice of a chair, which is unused and obstructs a way of players while a gaming machine is idle because no game is played on the gaming machine or because a game arcade is closed, etc. The inventors have considered that a use of the chair for protecting the liquid crystal display can also realize widening of a passage.

An object of the present invention is to provide a gaming machine capable of widening a passage and at the same time protecting a liquid crystal display.

According to an aspect of the present invention, there is provided a gaming machine comprising a display means, a chair, and a guide means. The display means displays game information. The chair includes a seat and a backrest. The guide means is connected to the chair, and capable of placing the chair in a sitting position which enables a player to sit on the seat and in a protecting position which makes the backrest protect the display means by covering a front side of the display means.

In this aspect, during a game the chair is placed in the sitting position which enables a player to sit on the seat, and while the gaming machine is idle the chair is placed in the protecting position which makes the backrest protect the display means by covering the front side of the display means. As a consequence, while the gaming machine is idle, the gaming machine can be compact to widen a passage, and moreover the display means can be protected from a player's attack out of rage about losing a game, etc.

### BRIEF DESCRIPTION OF THE DRAWINGS

Other and further objects, features and advantages of the invention will appear more fully from the following description taken in connection with the accompanying drawings in which:

FIG. 1 is a perspective view showing an appearance of a slot machine according to an embodiment of the present invention;

FIG. 2 schematically shows a liquid crystal display of the slot machine;

FIG. 3 schematically shows a control panel of the slot machine;

FIG. 4 is a perspective view showing a construction of the liquid crystal display;

FIG. 5 shows a development of a part of the liquid crystal display;

FIG. 6 is a perspective view showing an appearance of the slot machine whose chair is in a protecting position;

FIGS. 7A and 7B explanatorily show a chair movement mechanism;

FIGS. 8 and 9 are block diagrams showing an electrical construction of the slot machine;

FIG. 10 is a flowchart of a main routine that is executed by the slot machine; and

FIG. 11 is a flowchart of a chair-movement processing routine that is executed by the slot machine.

### DESCRIPTION OF THE PREFERRED EMBODIMENTS

In the following, a preferred embodiment of the present invention will be described with reference to the accompanying drawings.

A gaming machine according to this embodiment is a so-called slot machine in which a specific winning mode is established based on symbols that have been stopped after variably displayed. In the gaming machine, one plays a game using a game medium such as a coin, a medal, a gaming ball, a token, a card storing therein data about game values which have been or will be given to a player, or the like. In this embodiment, a description will be given on the assumption that the game medium is a coin.

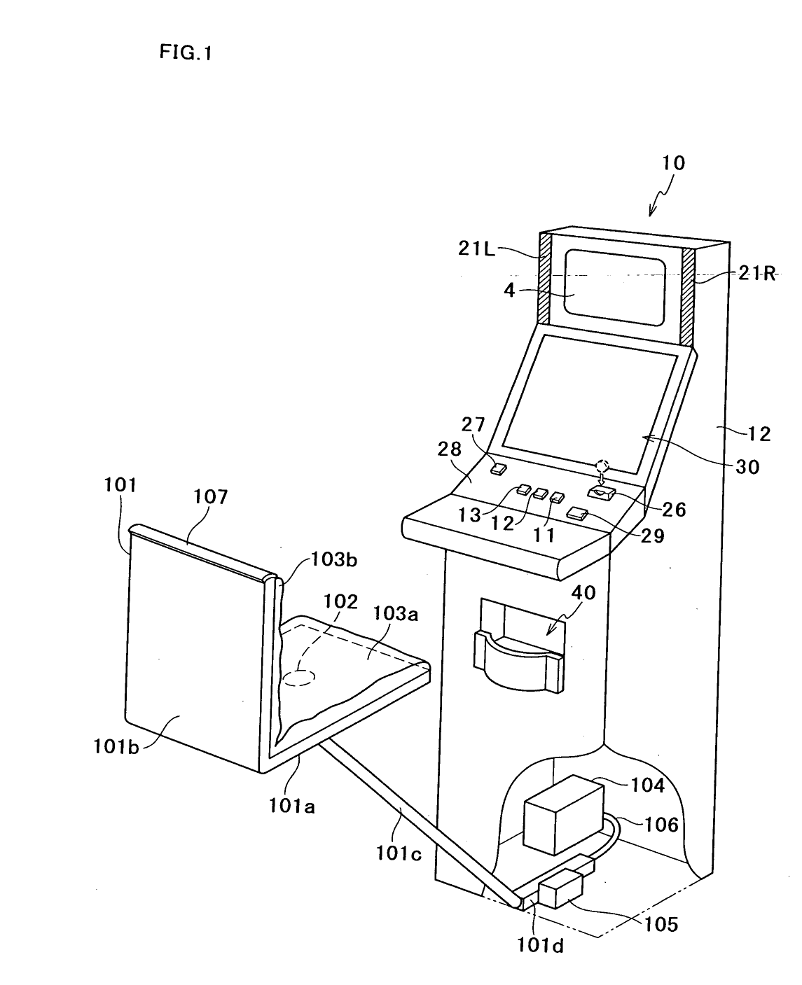

First, a general construction of a slot machine, which is a gaming machine according to an embodiment of the present invention, will be described with reference to FIG. 1.

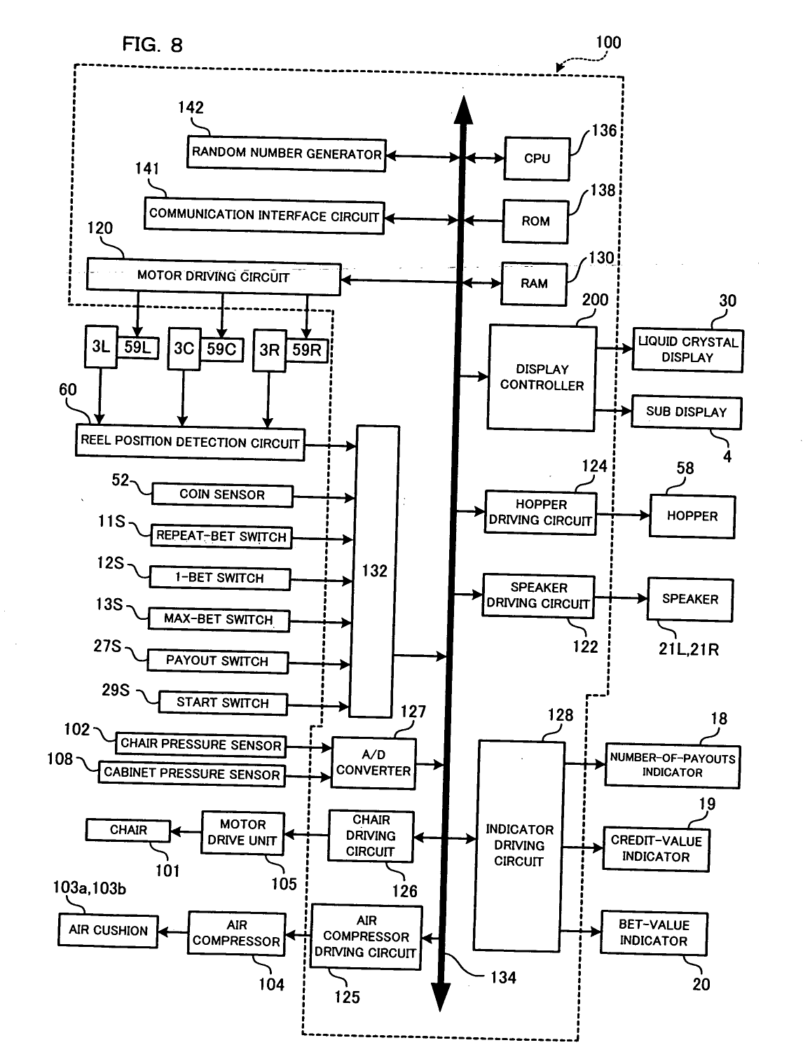

A slot machine 10 of this embodiment has a cabinet 12. A side of the cabinet 12 facing a player is opened. The cabinet 12 is placed at a predetermined position within a game arcade for example. Provided within the cabinet 12 are a controller 100 (see FIG. 8) that electrically controls the slot machine 10, a hopper 58 (see FIG. 8) that controls insertion, credit, and payout of coins, and the like. A liquid crystal display 30 is mounted substantially at a center of the cabinet 12.

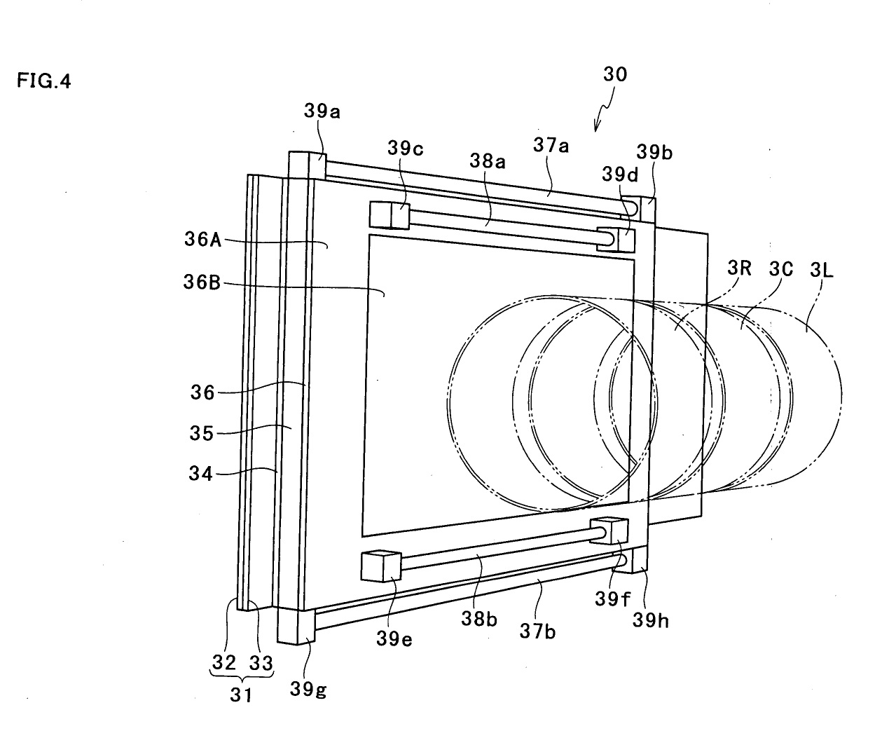

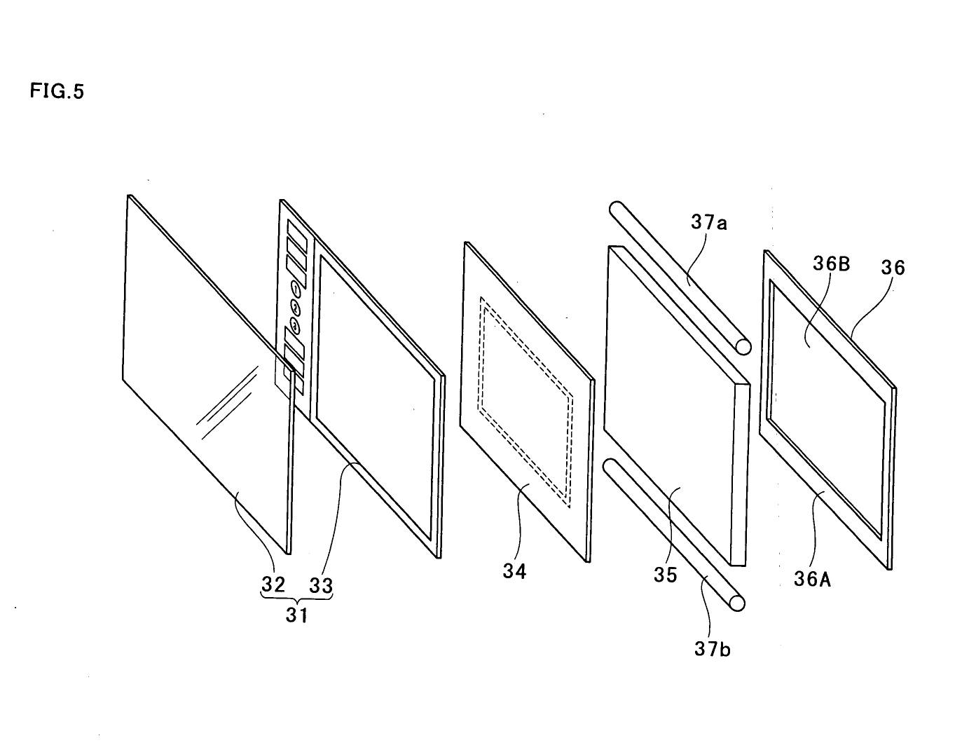

The liquid crystal display 30 is a device that displays various images for a game, including an effect image, an announcement image, and the like. While proceeding with a game, a player visually checks an image displayed on the liquid crystal display 30. The liquid crystal display 30 has a transparent liquid crystal panel 34 (see FIGS. 4 and 5). A part of the transparent liquid crystal panel 34 is switchable between a transparent state and an opaque state, and the transparent liquid crystal panel 34 is capable of displaying variable images. A more specific construction of the liquid crystal display 30 will be detailed later.

A sub display 4 is placed above the liquid crystal display 30. The sub display 4 displays an image for illustrating game contents, and the like. The sub display 4 may be a CRT (cathode-ray tube), a liquid crystal panel, a dot LED (light-emitting diode), a segment LED, a plasma display, or the like. Speakers 21L and 21R are provided on left and right sides of the sub display 4.

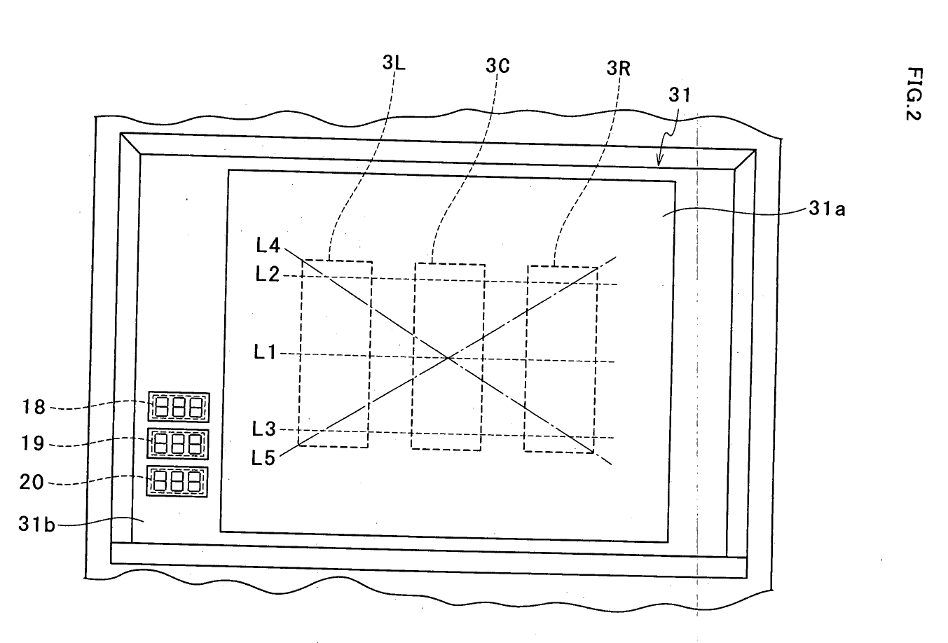

Behind the liquid crystal display 30, three rotatable reels 3L, 3C, and 3R are arranged side by side (see FIG. 2). A number of kinds of symbols are painted on an outer surface of each of the reels 3L, 3C, and 3R. While the transparent liquid crystal panel 34 is in the transparent state, the symbols painted on the respective reels 3L, 3C, and 3R are visible.

Although in this embodiment the liquid crystal display 30 locates in front of the reels 3L, 3C, and 3R, no particular limitation is put on where the liquid crystal display 30 is placed.

A substantially horizontal control panel 28 is provided below the liquid crystal display 30. The control panel 28 has a coin insertion slot 26 through which a coin is inserted into the slot machine 10.

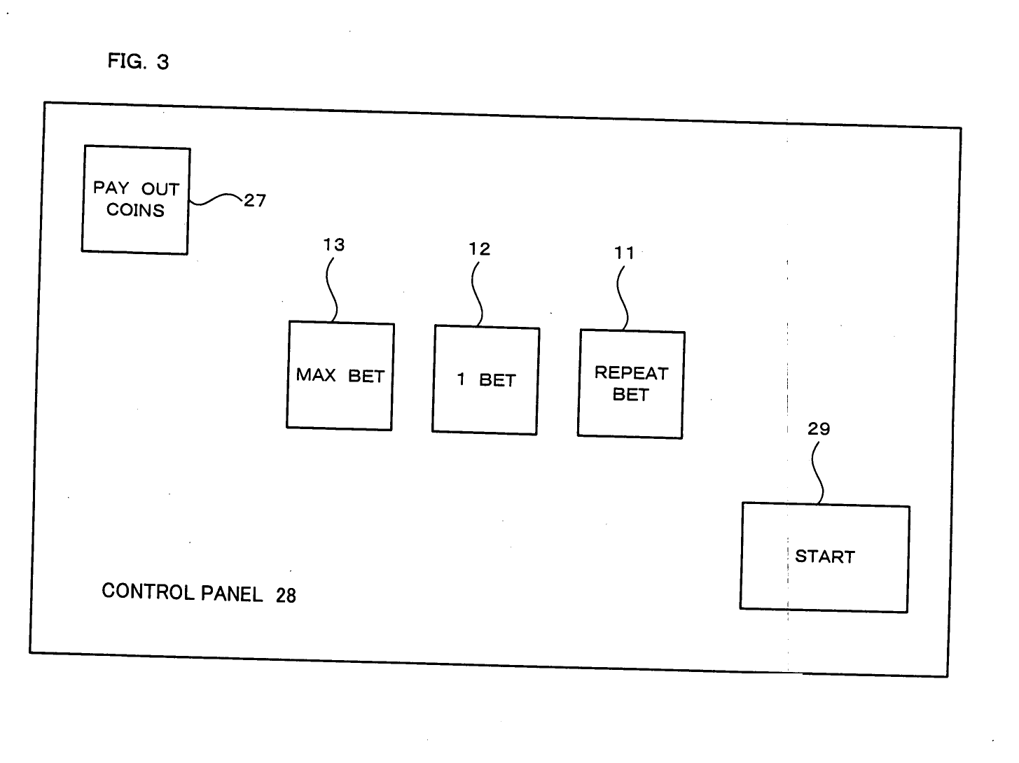

The control panel 28 will be described with reference to FIG. 3. In FIG. 3, illustration of the coin insertion slot 26 is omitted. A payout button 27 is provided in an upper-left portion of the control panel 28. When a player presses the payout button 27, coins inserted are paid out into a coin tray 40 that is an opening formed in a lower-front part of the cabinet 12 as shown in FIG. 1.

Referring to FIG. 3 again, a start button 29 that makes the reels 3L, 3C, and 3R start to rotate is provided in a lower-right portion of the control panel 28. In a substantially center of the control panel 28, three buttons are arranged in a row. The three buttons are, from left to right, a MAX-BET button 13, a 1-BET button 12, and a REPEAT-BET button 11.

Pressing the MAX-BET button 13 sets a BET value at the maximum value for one game. One press of the 1-BET button 12 causes one of credited coins to be bet on a game, and two presses of the 1-BET button 12 causes two of the credited coins to be bet on a game. Pressing the REPEAT-BET button 11 makes the BET value the same as the BET value for the last game. By pressing any of the BET buttons 11 to 13, one or more of paylines L1 to L5, which will be described later, are activated.

As shown in FIG. 4, the liquid crystal display 30 includes a front panel 31 and the transparent liquid crystal panel 34 that is provided behind the front panel 31. As shown in FIG. 2, the front panel 31 has a transparent display window 31a and a figure-formed region 31b in which figures are formed. An image displayed on the transparent liquid crystal panel 34 can be seen through the display window 31a of the front panel 31. When, in the transparent liquid crystal panel 34, an area that corresponds to the reels 3L, 3C, and 3R is in the transparent state, symbols painted on the reels 3L, 3C, and 3R are visible through the display window 31a.

As shown in FIG. 2, a number-of-payouts indicator 18, a credit-value indicator 19, and a BET-value indicator 20 are provided at a left side of the liquid crystal display 30. In the figure-formed region 31b of the front panel 31, an area that corresponds to the indicators 18 to 20 is transparent so that what are indicated by the indicators 18 to 20 can be seen.

Vertically three symbols can be seen on each of the three reels 3L, 3C, and 3R. In this case, generally five lines L1, L2, L3, L4, and L5 are defined as paylines. Each of the paylines L1 to L5 extends across the reels 3L, 3C, and 3R in such a manner that it passes over one of symbols that appear on each reel when all the reels 3L, 3C, and 3R stop rotating.

To be more specific, the payline L1 runs straight from side to side, passing over middle symbols of the respective reels 3L, 3C, and 3R. The payline L2 runs straight from side to side, passing over upper symbols of the respective reels 3L, 3C, and 3R. The payline L3 runs straight from side to side, passing over lower symbols of the respective reels 3L, 3C, and 3R. The payline L4 runs obliquely straight from up to down, passing over an upper symbol of the left reel 3L, a middle symbol of the middle reel 3C, and a lower symbol of the right reel 3R. The payline L5, which is an inversion of the payline L4, runs obliquely straight from down to up, passing over a lower symbol of the left reel 3L, a middle symbol of the middle reel 3C, and an upper symbol of the right reel 3R.

When a BET value is “1”, only the payline L1 is activated. Here, the BET value being “1” results from a press of the 1-BET button 12, or alternatively from insertion of one coin into the coin insertion slot 22. When the BET value is “two” which results from two presses of the 1-BET button 12 or insertion of two coins, a total of three lines including the paylines L2 and L3 in addition to the payline L1 are activated. When the BET value is maximum (i.e., three in this embodiment) which results from a press of the MAX-BET button 13 or five presses of the 1-BET button 12, a total of five lines including the paylines L4 and L5 in addition to the paylines L1 to L3 are activated. The activated paylines L1 to L5 concern whether a win is made or not. More specifically, when a combination of symbols that corresponds to a certain win stops on any activated payline (hereinafter referred to as “activated line”), the certain win is made.

The number-of-payouts indicator 18 indicates the number of coins which will be paid out upon a win. The credit-value indicator 19 indicates the number of coins which are credited in the slot machine 10. The BET-value indicator 20 indicates a BET value for each activated line. The indicators 18 to 20 are formed of 7-segment displays. Alternatively, it may also be possible that images of the indicators 18 to 20 are displayed on the transparent liquid crystal panel 34.

Next, the liquid crystal display 30 will be described in more detail with reference to FIGS. 4 and 5.

The liquid crystal display 30 has the front panel 31, the transparent liquid crystal panel 34, a light guide plate 35, a reflective film 36, fluorescent lamps 37a, 37b, 38a, 38b, lamp holders 39a, 39b, 39c, 39d, 39e, 39e, 39g, 39h, and a TCP (table carrier package). The front panel 31 includes a protective glass 32 and a display board 33. The fluorescent lamps 37a, 37b, 38a, 38bare so-called white light sources. An IC that drives the transparent liquid crystal panel 34 is mounted on the TCP. The TCP, although not shown in FIGS. 4 and 5, includes a flexible substrate (not shown) that is connected to a terminal of the transparent liquid crystal panel 34.

The liquid crystal display 30 is placed in front of the reels 3L, 3C, and 3R so as to extend over the reels 3L, 3C, and 3R. A predetermined amount of space is formed between the liquid crystal display 30 and the reels 3L, 3C, and 3R.

The protective glass 32 and the display board 33 are respectively made of transparent members. The protective glass 32 protects the transparent liquid crystal panel 34. In the display board 33, figures, etc. are painted on a region corresponding to the figure-formed region 31b of the front panel 31 (see FIG. 2), and nothing is painted on a region corresponding to the display window 31a of the front panel 31 (see FIG. 2). Alternatively, it may also be possible to eliminate the figure-formed region 31b and instead to extend the display window 31a over a whole area of the front panel 31. In this case, nothing is painted on any region of the display board 33, or the display board 33 may be omitted.

Although not shown in FIGS. 4 and 5, an electric circuit that operates the indicators 18 to 20 is disposed behind the display board 33.

The transparent liquid crystal panel 34 is formed by a transparent substrate such as a glass plate having a thin-film transistor layer, a transparent substrate that is positioned opposite to the former transparent substrate, and liquid crystal that is enclosed in a gap between the two transparent substrates. A display mode of the transparent liquid crystal panel 34 is Normally White mode. Here, the Normally White mode means that, when liquid crystal is not activated, a white-color display is shown, that is, light transmitted from the rear to the front of the transparent liquid crystal panel 34 can be seen from the outside. By adopting the transparent liquid crystal panel 34 with the Normally White display mode, a player can continue to play a game even if the liquid crystal accidentally becomes unactivatable, because he/she can still see symbols that are variably displayed and stopped on the reels 3L, 3C, and 3R. Thus, even if such an accident occurs, the player can continue playing a game that is based mainly on variably displaying and stopping symbols on the respective reels 3L, 3C, and 3R.

The light guide plate 35 serves for guiding light, which is emitted from the fluorescent lamps 37aand 37b, to the transparent liquid crystal panel 34. That is, the light guide plate 35 serves for illuminating the transparent liquid crystal panel 34. The light guide plate 35 is disposed behind the transparent liquid crystal panel 34, and made of a transparent material having a light-guiding function, e.g., an acrylic resin having a thickness of approximately 2 cm.

The reflective film 36 has a reflective area 36A and a transparent area 36B. The reflective area 36A is made of, for example, a white polyester film or aluminium film having an evaporated silver film formed thereon. The reflective area 36A reflects light, which has been guided by the light guide plate 35, toward the front side of the light guide plate 35. The transparent area 36B of the reflective film 36 is made of a transparent material. The transparent area 36B corresponds to an area of the transparent display window 31a (see FIG. 2) of the front panel 31 that covers the front part of the reels 3L, 3C, and 3R.

The fluorescent lamps 37a and 37b are disposed along top and bottom edges of the light guide plate 35, respectively. Both ends of the fluorescent lamps 37aand 37b are supported on a pair of lamp holders 39a and 39b and a pair of lamp holders 39g and 39h, respectively. Light emitted from the fluorescent lamps 37a and 37b is reflected by the reflective area 36A of the reflective film 36, and illuminates the transparent liquid crystal panel 34.

The fluorescent lamps 38a and 38b are disposed behind the reflective film 36 and located at a little lower and a little upper positions than the fluorescent lamps 37a and 37b, respectively. Both ends of the fluorescent lamps 38a and 38b are supported on a pair of lamp holders 39c and 39d and a pair of lamp holders 39e and 39e, respectively. Light emitted from the fluorescent lamps 38a and 38b is reflected by the surfaces of the reels 3L, 3C, and 3R, and launched into the transparent area 36B, thus illuminating the transparent liquid crystal panel 34.

Like this, in the liquid crystal display 30, the transparent liquid crystal panel 34 is illuminated by light that is emitted from the fluorescent lamps 37a and 37b and reflected by the reflective area 36A of the reflective film 36, and by light that is emitted from the fluorescent lamps 38a and 38b, reflected by the surfaces of the reels 3L, 3C, and 3R, and launched into the transparent area 36B of the reflective film 36. Therefore, such a region of the liquid crystal display 30 that corresponds to the transparent area 36B of the reflective film 36 is switchable between a transparent state and an opaque state depending on whether liquid crystal is activated or not. Such a region of the liquid crystal display 30 that corresponds to the reflective area 36A of the reflective film 36 remains in an opaque state regardless of whether liquid crystal is activated or not.

In this embodiment, only a part of a display screen of the liquid crystal display 30 is switchable between the transparent state and the opaque state. However, it may also be possible that a whole area of the display screen of the liquid crystal display 30 is switchable between the transparent state and the opaque state. In such a case, the transparent area 36B is extended throughout a whole of the reflective film 36, or alternatively the reflective film 36 is eliminated.

It may be possible that the protective glass 32 of the front panel 31 is a touch panel so that the liquid crystal display 30 receives an input made through the touch panel.

Next, a chair 101 provided to the slot machine 10 will be described.

As shown in FIG. 1, the chair 101 is placed opposite to the cabinet 12. The chair 101 has a seat 101a on which a player sits, a backrest 101b against which a player leans his/her back, a support column 101c that extends downward from a substantially center of an under face of the seat 101a, and a slide member 101d that is connected to the support column 101c. The slide member 101d, which functions as a guide means of the present invention, is slidable horizontally along a bottom face of the cabinet 12. In association with sliding of the slide member 101d, an inclination angle of the support column 101c varies.

Air cushions 103a and 103b are provided on the seat 101a and the backrest 101b, respectively. A player sitting on the chair 101 is in contact with the air cushions 103a and 103b. The air cushions 103a and 103b are inflated when air is supplied thereto, and deflated when the air is discharged therefrom. A damper 107 made of an elastic material such as a rubber is provided on an upper edge of the backrest 101b. At a substantially center of the seat 101a, a seat pressure sensor 102 is mounted.

Instead of the seat pressure sensor 102, a temperature sensor or a light sensor may be mounted. Instead of the air cushions 103a and 103b, a water cushion in which water can be filled, etc., may be employed so that an impression of dignity and quality is put on the chair 101.

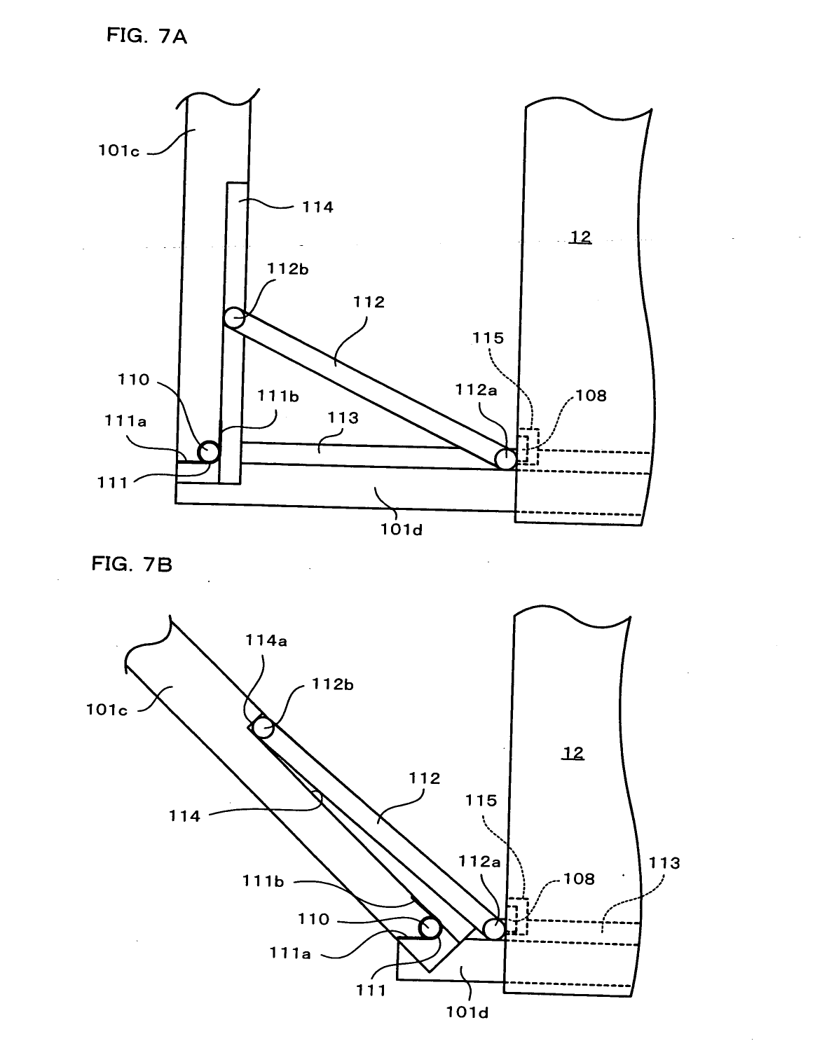

A motor drive unit 105, a hose 106, an air compressor 104, and a cabinet pressure sensor 108 (see FIGS. 7A and 7B) are provided within the cabinet 12. The motor drive unit 105 functions as a movement means for moving the chair 101 between a sitting position and a protecting position which will be described later. The motor drive unit 105 is engaged with the slide member 101d, and makes the slide member 101d slide in a horizontal direction by means of a motor (not shown). Thereby, the slide member 101d is advanced to a front of the cabinet 12, or the slide member 101d positioned in front of the cabinet 12 is retracted into the cabinet 12. One end of the hose 106 is connected to the air compressor 104, and the other end thereof goes through the slide member 101d and the support column 101c and communicates with the air cushions 103a and 103b. Through the hose 106, the air compressor 104 supplies and discharges air to and from the air cushions 103a and 103b. The cabinet pressure sensor 108 (see FIGS. 7A and 7B) is provided on an outer wall of the cabinet 12 so as to come into contact with a bar 112, which will be described later, thereby sensing pressure received from the bar 112.

During a game, the chair 101 takes a sitting position as shown in FIG. 1. When the chair 101 is in the sitting position, almost all length of the slide member 101d locates inside the cabinet 12 and therefore the support column 101c is inclined. The air cushions 103a and 103b are inflated because the air compressor 104 has supplied air thereto. The air cushions 103a and 103b thus inflated make the chair 101 comfortable for a player to sit on. The chair pressure sensor 102 senses pressure that is given by a player sitting on the chair 101.

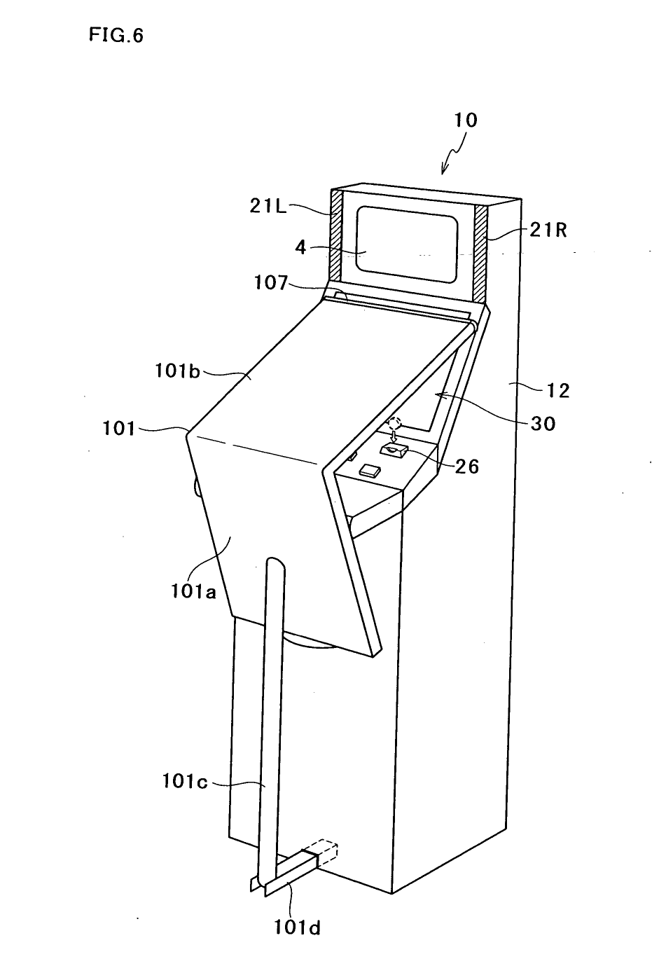

While the slot machine 10 is idle because, for example, no game is played on the slot machine 10 or a game arcade is closed, etc., the chair 101 takes a protecting position as shown in FIG. 6. When the chair 101 is in the protecting position, the slide member 101d is advanced to the front of the cabinet 12 and therefore the support column 101c is standing up. The air cushions 103a and 103b are deflated because the air compressor 104 has discharged air therefrom. At this time, the damper 107 absorbs impact caused upon a collision between the backrest 101b and the liquid crystal display 30.

Next, a movement mechanism for the chair 101 will be described with reference to FIGS. 7A and 7B. FIGS. 7A and 7B show the chair 101 that takes the protecting position and the sitting position, respectively. In FIGS. 7A and 7B, illustration of the motor drive unit 105, the hose 106, etc. are omitted.

When the chair 101 is in the protecting position, referring to FIG. 7A, the slide member 101d is advanced to the front of the cabinet 12 by means of the motor drive unit 105 (see FIG. 1) and thus the support column 101c stands up. Spaces 113 and 114 are formed in the slide member 101d and the support column 101c, respectively. The spaces 113 and 114 extend along longitudinal directions of the slide member 101d and the support column 101c, respectively. One end 112a of the bar 112 is fitted in the space 113, and the other end 112b of the bar 112 is fitted in the space 114. The one end 112a of the bar 112 slides within the space 113, and the other end 112b of the bar 112 slides within the space 114. A stopper 115 is provided on the outer wall of the cabinet 12 so that it locates substantially at the same position as the position of the cabinet pressure sensor 108. The stopper 115 comes into contact with the one end 112a of the bar 112, thus inhibiting the bar 112 from sliding further toward the cabinet 12. The one end 112a of the bar 112 comes into contact with the cabinet pressure sensor 108 which thereby senses pressure received from the bar 112.

A shaft 110 is provided at a connecting portion between the slide member 101d and the support column 101c. A torsion spring 111 is wound around the shaft 110. The torsion spring 111 has a first arm 111a fixed to the slide member 101d, and a second arm 111b fixed to the support column 101c. In an initial state, the torsion spring 111 has a winding angle of approximately 90 degrees. In a state shown in FIG. 7A, the torsion spring 111 presents no elastic deformation and keeps the support column 101c standing upright. The torsion spring 111 absorbs force that is directed to push the support column 101c toward the cabinet 12, and elastically deforms so as to reduce its winding angle when receiving force that is directed to push the support column 101c away from the cabinet 12.

When the chair 101 is in the sitting position, referring to FIG. 7B, the slide member 101d, except the connecting portion between the slide member 101d and the support column 101c, is retracted by the motor drive unit 105 (see FIG. 1) into the cabinet 12, so that the support column 101c is inclined. The one end 112a of the bar 112, which is placed within the space 113, comes into contact with the stopper 115 and with the cabinet pressure sensor 108. The other end 112b of the bar 112, which is placed within the space 114, is at an upper end 114a of the space 114. At this time, the bar 112 struts the support column 101c. As a result, the support column 101c is inclined, and the torsion spring 111 is elastically deformed so as to reduce its winding angle. In this state, as compared with when the chair 101 is in the protecting position (see FIG. 7A), the cabinet pressure sensor 108 senses higher pressure. The torsion spring 111 exhibits elastic force that is directed toward the initial winding angle, i.e., 90 degrees, but strut force of the bar 112 acting on the support column 101c is larger than the elastic force. Accordingly, the support column 101c is kept inclined.

A movement of the chair 101 from the protecting position of FIGS. 6 and 7A to the sitting position of FIGS. 1 and 7B is triggered by, for example, a player pulling the backrest 101b of the chair 101, which is in the protecting position, away from the liquid crystal display 30. In the state shown in FIG. 6, when the backrest 101b is pulled away from the liquid crystal display 30, pressure of the bar 112 acting on the cabinet pressure sensor 108 is largely varied. When a degree of the pressure variation becomes equal to or higher than a threshold value, the motor drive unit 105 (see FIG. 1) is driven and retracts the slide member 101d into the cabinet 12, to incline the support column 101c and thus place the chair 101 into the sitting position as shown in FIGS. 1 and 7B. Then, the air compressor 104 supplies air to the air cushions 103a and 103b which are thereby inflated.

To be more specific, in the state shown in FIG. 7A, when retraction of the slide member 101d into the cabinet 12 starts, the one end 112a of the bar 112, which is in contact with the stopper 115, is pressed. Relative to this, the other end 112b of the bar 112 is sliding upward within the space 114. When the other end 112b of the bar 112 reaches the upper end 114aof the space 114, the other end 112b of the bar 112 presses the support column 101c to incline the support column 101c. Along with this, the torsion spring 111 is elastically deformed so as to reduce its winding angle. When the movement of the slide member 101d is stopped, the chair 101 takes the sitting position with the support column 101c being inclined, as shown in FIG. 7B.

The chair 101 is kept in the sitting position of FIGS. 1 and 7B, as long as the chair pressure sensor 102 is sensing pressure and, moreover, until a predetermined period of time elapses even after the chair pressure sensor 102 stops sensing pressure. Here, the predetermined period of time may be set at 30 minutes, which is a little longer than a time period generally required for a player to use a restroom and the like.

A movement of the chair 101 from the sitting position of FIGS. 1 and 7B to the protecting position of FIGS. 6 and 7A is triggered by elapse of the predetermined period of time after the chair pressure sensor 102 stops sensing pressure. That is, in the state where the chair 101 is in the sitting position as shown in FIG. 1, when the predetermined period of time elapses after the chair pressure sensor 102 stops sensing pressure, the air compressor 104 discharges air from the air cushions 103a and 103b which are thereby deflated. Then, the motor drive unit 105 is driven and advances the slide member 101d to the front of the cabinet 12, so that the support column 101c stands up and the chair 101 is placed in the protecting position as shown in FIG. 6.

To be more specific, in the state shown in FIG. 7B, when advance of the slide member 101d to the front of the cabinet 12 starts, the support column 101c gradually stands up by means of elastic force of the elastically-deformed torsion spring 111 while the one end 112a of the bar 112 is kept in contact with the stopper 115. Along with further advance of the slide member 101d, the other end 112b of the bar 112, which is positioned at the upper end 114a of the space 114, leaves the upper end 114a and slides downward within the space 114. Then, the winding angle of the torsion spring 111 returns to 90 degrees, and the movement of the slide member 101d is stopped. Thus, the chair 101 takes the protecting position with the support column 101c standing up, as shown in FIG. 7A.

Next, the controller 100 of the slot machine 10 will be described with reference to FIG. 8.

The controller 100 is a microcomputer, and includes an interface circuit unit 132, an input/output bus 134, a CPU 136, a ROM 138, a RAM 130, a communication interface circuit 141, a random number generator 142, a motor driving circuit 120, a speaker driving circuit 122, a hopper driving circuit 124, an indicator driving circuit 128, an A/D converter 127, a chair driving circuit 126, an air-compressor driving circuit 125, and a display controller 200.

The interface circuit unit 132 is connected to the input/output bus 134. The input/output bus 134 inputs and outputs, with the CPU 136, a data signal and an address signal.

Connected to the interface circuit unit 132 are a coin sensor 52, a REPEAT-BET switch 11S, a 1-BET switch 12S, a MAX-BET switch 13S, a payout switch 27S, and a start switch 29S. The coin sensor 52 placed within the coin insertion slot 26 senses a coin inserted into the coin insertion slot 26. The start switch 29S is provided inside the start button 29. A sensing signal outputted from the coin sensor 52 to the interface circuit unit 132, sensing signals outputted from the respective switches 11S, 12S, 13S, 27S to the interface circuit unit 132, a starting signal outputted from the switch 29S to the interface circuit unit 132 are, in the interface circuit unit 132, converted into predetermined signals and then supplied to the input/output bus 134.

In addition, a reel position detection circuit 60 is connected to the interface circuit unit 132. The reel position detection circuit 60 detects rotational positions of the respective reels 3L, 3C, and 3R based on a pulse signal received from a reel rotational position sensor (not shown). A detection signal outputted from the reel position detection circuit 60 to the interface circuit unit 132 is also converted into a predetermined signal in the interface circuit unit 132, and then supplied to the input/output bus 134.

The ROM. 138 and the RAM 130 as well are connected to the input/output bus 134.

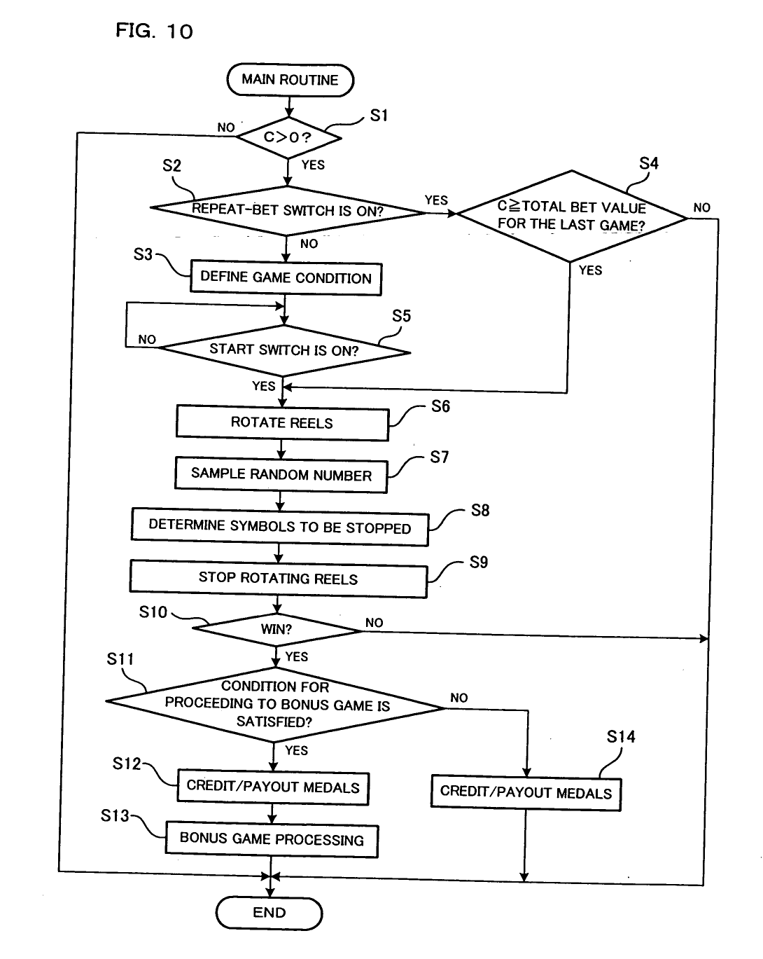

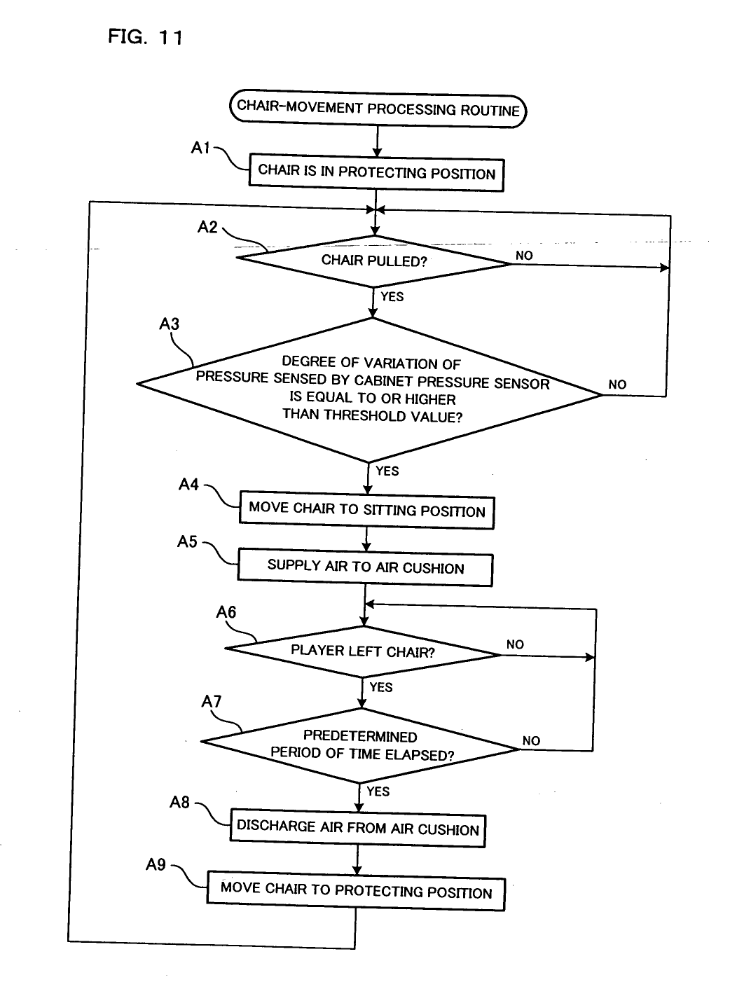

The ROM 138 stores therein a control program for controlling the slot machine 10 overall, a program for executing routines of FIGS. 10 and 11, initial data used for executing the control program, various data tables used for a random-number lottery that is held upon every press of the start button 29, and the like. Here, the various data tables are, for example, a lottery table, a symbol-arrangement table, a winning form table, etc. These data tables include not only ones used for a base game but also ones used for a bonus game. In the winning form table, each one of winning combinations is associated with the number of payout coins.

Referring to FIG. 8 again, the RAM 130 temporarily stores therein a flag, a variable, and the like that are used in the control program. For example, data about the number of inserted coins is stored in the RAM 130. Moreover, the RAM 130 stores therein data about a predetermined period of time from when the chair pressure sensor 102 stops sensing pressure to when movement of the chair 101 from the sitting position to the protecting position is started. In this embodiment, the predetermined period of time is set at 30 minutes. The predetermined period of time can be changed by rewriting memory contents of the RAM 130.

Further, the communication interface circuit 141 is connected to the input/output bus 134. The communication interface circuit 141 communicates with a server, etc., via various communication networks including a public telephone network, a LAN, or the like.

The random number generator 142 that generates a random number is also connected to the input/output bus 134. At the timing when the start button 29 is pressed, the random number generator 142 generates a random number belonging to a certain range, for example, a range from “0” to “65535 (16th power of 2)”. Alternatively, a random number may be generated based on a computation by the CPU 136.

The motor driving circuit 120 for driving stepping motors 59L, 59C, and 59R and the indicator driving circuit 128 for driving the indicators 18 to 20 are also connected to the input/output bus 134. In response to occurrence of a predetermined event, the CPU 136 controls, via the driving circuits 120 and 128, operations of the indicators 18 to 20 and operations of the stepping motors 59L, 59C, 59R.

The speaker driving circuit 122 for driving the speakers 21L and 21R is also connected to the input/output bus 134. The CPU 136 reads sound data out of the ROM 138, and transmits the sound data to the speaker driving circuit 122 through the input/output bus 134. In this way, an effect sound is emitted from the speakers 21L and 21R.

The hopper driving circuit 124 for driving the hopper 58 is also connected to the input/output bus 134. When a payout signal is inputted from the payout switch 27S, the CPU 136 outputs a drive signal through the input/output bus 134 to the hopper driving circuit 124. The hopper 58 accordingly pays out coins the number of which is equivalent to a current credit amount stored in a predetermined memory area of the RAM 130.

The chair pressure sensor 102 is also connected to the input/output bus 134 via the A/D converter 127. When a predetermined period of time has elapsed after an input of a pressure detection signal from the chair pressure sensor 102 stops, the CPU 136 determines that no game is being played in the slot machine 10, that is, the slot machine 10 is in an idle state, and moves the chair 101 from the sitting position to the protecting position.

The cabinet pressure sensor 108 is also connected to the input/output bus 134 via the A/D converter 127. When a degree of variation of pressure sensed by the cabinet pressure sensor 108 becomes equal to or higher than a threshold value, the CPU 136 determines that a player is intending to play a game in the slot machine 10, and moves the chair 101 from the protecting position to the sitting position.

The chair driving circuit 126 for driving the motor drive unit 105 is also connected to the input/output bus 134. When a predetermined period of time has elapsed after the chair pressure sensor 102 stops sensing pressure, the CPU 136 determines that no game is being played in the slot machine 10, and outputs a drive signal to the chair driving circuit 126 through the input/output bus 134. The motor drive unit 105 is accordingly driven, to move the chair 101 from the sitting position to the protecting position. When a degree of variation of pressure sensed by the cabinet pressure sensor 108 becomes equal to or higher than a threshold value, the CPU 136 determines that a player is intending to play a game in this slot machine 10, and outputs a drive signal to the chair driving circuit 126 through the input/output bus 134. The motor drive unit 105 is accordingly driven, to move the chair 101 from the protecting position to the sitting position.

The air-compressor driving circuit 125 for driving the air compressor 104 is also connected to the input/output bus 134. At the time when the chair 101 starts moving from the sitting position to the protecting position, the CPU 136 outputs a drive signal to the air-compressor driving circuit 125 through the input/output bus 134. The air compressor 104 is accordingly driven, so that air is discharged from the air cushions 103a and 103b before the chair 101 starts moving from the sitting position to the protecting position. At the time when the movement of the chair 101 from the protecting position to the sitting position is completed, the CPU 136 outputs a drive signal to the air-compressor driving circuit 125 through the input/output bus 134. The air compressor 104 is accordingly driven, so that air is supplied to the air cushions 103a and 103b after the movement of the chair 101 from the protecting position to the sitting position is completed.

The display controller 200 is also connected to the input/output bus 134. The CPU 136 generates an image-display command in accordance with a game status and a game result, and outputs the image-display command to the display controller 200 through the input/output bus 134. When the image-display command is inputted from the CPU 136, the display controller 200 generates, based on this image-display command, a drive signal for driving the liquid crystal display 30 and the sub display 4, and then outputs the drive signal to the liquid crystal display 30 and the sub display 4. Consequently, a certain image is displayed on the transparent liquid crystal panel 34 of the liquid crystal display 30, and an image that illustrates game contents is displayed on the sub display 4.

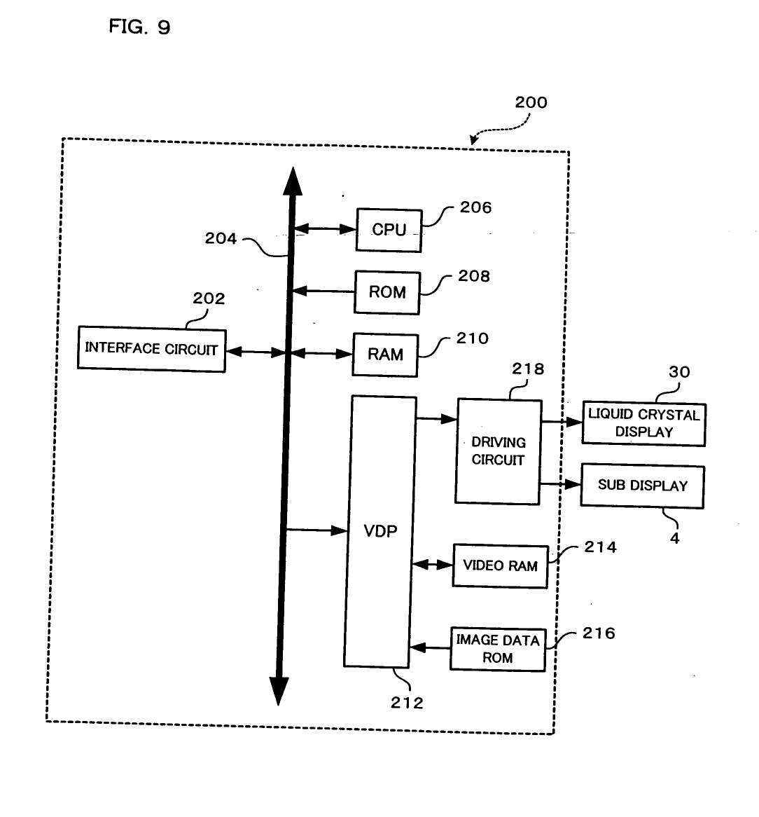

Next, the display controller 200 will be described in more detail with reference to FIG. 9.

The display controller 200 is a sub-microcomputer that performs an image display processing, and includes an interface circuit 202, an input/output bus 204, a CPU 206, a ROM 208, a RAM 210, a VDP 212, a video RAM 214, an image-data ROM 216, and a driving circuit 218.

The interface circuit 202 is connected to the input/output bus 204. An image-display command outputted from the CPU 136 of the controller 100 is fed to the input/output bus 204 via the interface circuit 202. The input/output bus 204 inputs/outputs a data signal or an address signal to/from the CPU 206.

The ROM 208 and the RAM 210 are also connected to the input/output bus 204. The ROM 208 stores therein a display-control program for generating, based on an image-display command received from the CPU 136 of the controller 100, a drive signal which will be fed to the liquid crystal display 30 and the sub display 4. The RAM 210 stores therein a flag, a variable, and the like that are used in the display-control program.

The VDP 212 is also connected to the input/output bus 204. The VDP 212, including a so-called sprite circuit, a screen circuit, a pallet circuit or the like, is a processor capable of various processings in order to display images on the liquid crystal display 30 and the sub display 4. The video RAM 214 and the image-data ROM 216 are connected to the VDP 212. The video RAM 214 stores therein video data that corresponds to an image-display command received from the CPU 136 of the controller 100. The image-data ROM 216 stores therein various image data including an effect image and the like. The driving circuit 218, which is also connected to the VDP 212, outputs a drive signal for driving the liquid crystal display 30 and the sub display 4.

The CPU 206 reads the display-control program out of the ROM 208 and executes the display-control program, thereby storing into the video RAM 214 image data which corresponds to an image-display command received from the CPU 136 of the controller 100 and which will be displayed on the liquid crystal display 30 and the sub display 4. The image-display command includes an effect-image display command and the like.

FIGS. 10 and 11 show routines that are executed by the controller 100 in order to control the slot machine 10. The routines shown in FIGS. 10 and 11 are called upon at a predetermined timing in the course of a main program of the slot machine 10 which is being executed in advance. In the following, a description will be given on the assumption that the slot machine 10 has been activated in advance and a variable used by the CPU 136 of the controller 100 is initialized at a predetermined value so that the slot machine 10 is in a steady-state operation.

The main routine will be described with reference to FIG. 10.

First, the CPU 136 of the controller 100 reads out a credit value C that is stored in the RAM 130. Based on the credit value C, the CPU 136 determines whether there remains any credit, which means the number of coins reserved, or not (S1). When the credit value C is “0” (S1: NO), the CPU 136 determines that a game cannot start, and ends this routine without any processing. When the credit value C is equal to or more than “1” (S1: YES), the CPU 136 determines that a credit remains, and shifts the processing to S2.

In S2, the CPU 136 determines whether the REPEAT-BET switch 11S is on or not, that is, whether a switching signal is outputted from the REPEAT-BET switch 11S as a result of the REPEAT-BET button 11 being pressed, or not. When a switching signal is outputted from the REPEAT-BET switch 11S (S2: YES), the CPU 136 shifts the processing to S4. When a switching signal is not outputted from the REPEAT-BET switch 11S even after a predetermined period of time elapsed (S2: NO), the CPU 136 determines that the REPEAT-BET switch 11S is not pressed, and shifts the processing to S3.

In S3, a game condition is defined. More specifically, based on a switching signal received from the MAX-BET switch 13S or the 1-BET switch 12S, the CPU 136 determines a total BET value for the present game. At this time, the CPU 136 receives a switching signal, which has been issued from the switch 13S or 12S in response to a press of the BET button 13 or 12. Then, based on a kind of the switching signal and on the number of receptions of the switching signal, the CPU 136 determines a total BET value, and stores data about this total BET value into a predetermined memory area of the RAM 130. The CPU 136 reads out a credit value C that is stored in the RAM 130, and subtracts the total BET value from the read-out credit value C. Then, the CPU 136 stores a resulting value into a predetermined memory area of the RAM 130.

After defining a game condition in S3, the CPU 136 determines whether the start switch 29S is on or not, that is, whether a starting signal is outputted from the start switch 29S as a result of the start button 29 being pressed, or not (S5). When a starting signal is outputted (S5: YES), the CPU 136 shifts the processing to S6.

In S4, the CPU 136 reads out a credit value C and a total BET value for the last game, which have been written into a predetermined area of the RAM 130. Then, the CPU 136 determines whether the credit value C is equal to or more than the total BET value for the last game, or not. When the credit value C is less than the total BET value for the last game (S4: NO), the CPU 136 determines that a game cannot start, and ends this routine without any processing. When the credit value C is equal to or more than the total BET value for the last game (S4: YES), the CPU 136 subtracts the total BET value for the last game from the credit value C. Then, the CPU 136 stores a resulting value into a predetermined memory area of the RAM 130. Thereafter, the CPU 136 shifts the processing to S6.

In S6, based on a symbol arrangement table stored in the RAM 130, the CPU 136 rotates the reels 3L, 3C, and 3R either sequentially or simultaneously.

To be more specific, after the CPU 136 starts rotating the reels 3L, 3C, and 3R, the CPU 136 counts the number of drive pulses that have been transmitted to the respective stepping motors 59L, 59C, and 59R. Then, the CPU 136 stores a count value into a predetermined memory area of the RAM 130. Upon every one rotation of each of the reels 3L, 3C, and 3R, a reset pulse is obtained. This reset pulse is inputted to the CPU 136 via the reel position detection circuit 60. When a reset pulse is inputted, the CPU 136 sets a drive-pulse count value, which is written in the RAM 130, to “0”. As a result, stored in the predetermined memory area of the RAM 130 is a count value that corresponds to a rotational position of each of the reels 3L, 3C, and 3R in a range of one rotation thereof. In the symbol arrangement table, a rotational position of each of the reels 3L, 3C, and 3R is associated with each kind of symbols painted on the reel. In referring to the symbol arrangement table, the CPU 136 uses a position at which a reset pulse is obtained as a benchmark, and associates code numbers with symbol codes. The code numbers are given at every predetermined rotation pitch of each of the reels 3L, 3C, and 3R. The symbol codes are assigned to the symbols, and correspond to the respective code numbers.

After S6, the CPU 136 samples a random number for determining which symbols will be stopped, by means of the random number generator 142 (S7). Then, based on the sampled random number, the CPU 136 determines symbols which will be stopped (S8). Then, the CPU 136 stops rotation of the reels 3L, 3C, and 3R either sequentially or simultaneously (S9).

After all the reels 3L, 3C, and 3R stop rotating, the CPU 136 determines, based on a condition of a winning flag for an activated line, whether a winning combination is made or not (S10). When the winning flag is not set ON (S10: NO), the CPU 136 determines that a winning combination is not made, and ends this routine. When the winning flag is set ON (S10: YES), the CPU 136 determines that a winning combination is made, and shifts the processing to S11.

In S11, the CPU 136 determines, based on a kind of the winning flag stored in the RAM 130, whether a condition for proceeding to a bonus game is satisfied or not. When the flag set ON is a flag representing a winning combination that permits a bonus game, i.e., representing a bonus-game permitting combination, the CPU 136 determines that a condition for proceeding to a bonus game is satisfied (S11: YES), and shifts the processing to S12. When the flag set ON is not a flag representing a combination that permits a bonus game, the CPU 136 determines that a condition for proceeding to a bonus game is not satisfied (S11: NO), and shifts the processing to S14.

In S12, based on the number of payout coins for the bonus-game permitting combination, which is written in a predetermined memory area of the RAM 130, the CPU 136 pays out coins in a predetermined form. At this time, the CPU 136 reads out a credit value that is stored in a predetermined memory area of the RAM 130, and adds the number of payout coins to the credit value. Then, the CPU 136 stores a resulting value into a predetermined memory area of the RAM 130, and at the same time makes the credit-value indicator 19 indicate the resulting value.

After a payout for the bonus-game permitting combination in S12, the CPU 136 executes a bonus-game processing (S13). A bonus game means, for example, that a predetermined number of games can be played without betting any coin. In this embodiment, 15 free games can be played. For executing the bonus-game processing, the CPU 136 reads out a bonus-game lottery table and a bonus-game winning form table that are stored in the ROM 138. Then, the CPU 136 rewrites a base-game lottery table and a base-game winning form table that are stored in a predetermined memory area of the RAM 130, into the bonus-game lottery table and the bonus-game winning form table. In the bonus-game lottery table, a frequency of occurrence of a win is higher than in the base-game lottery table. The CPU 136 stores data of a predetermined number of bonus games (which is “15” in this embodiment) into a predetermined memory area of the RAM 130. Consequently, during the bonus game, a player can play 15 games for example, with a higher possibility of win. This makes the game more attractive to a player. After S13, the CPU 136 ends this routine.

In S14, based on the number of payout coins for a winning combination other than the bonus-game permitting combination, which is written in a predetermined memory area of the RAM 130, the CPU 136 pays out coins in a predetermined form. At this time, the CPU 136 reads out a credit value C that is stored in a predetermined memory area of the RAM 130, and adds the number of payout coins to the credit value C. Then, the CPU 136 stores a resulting value into a predetermined memory area of the RAM 130, and at the same time makes the credit-value indicator 19 indicate the resulting value. After S14, the CPU 136 ends this routine.

In S12 and in S14, the number of payout coins is stored as a credit. However, it may be possible to transmit a payout command to the hopper driving circuit 124 to thereby actually pay out coins through the hopper 58 into the coin tray 40.

A chair-movement processing routine will be described with reference to FIG. 11. The controller 100 executes the chair-movement processing routine independently from the main routine.

At the time when the slot machine 10 is powered up, the chair 101 is in the protecting position as shown in FIG. 6 (A1). Then, the CPU 136 determines whether a player has, in order to play a game, pulled the backrest 101b of the chair 101 away from the liquid crystal display 30, or not (A2). When a player has not pulled the chair 101 (A2: NO), the processing repeats A2. When a player has pulled the backrest 101b of the chair 101 (A2: YES), the CPU 136 then determines whether a degree of variation of pressure sensed by the cabinet pressure sensor 108 is equal to or higher than a threshold value, or not (A3). When a degree of variation of pressure is less than a threshold value (A3: NO), the CPU 136 determines that a player has merely made a slight touch to the chair 101. Thus, the CPU 136 returns the processing to A2.

When a degree of variation of pressure sensed by the cabinet pressure sensor 108 is equal to or higher than a threshold value (A3: YES), the CPU 136 determines that a player is intending to play a game in this slot machine 10, and moves the chair 101 to the sitting position as shown in FIG. 1 (A4). To be more specific, the CPU 136 drives the motor drive unit 105 so as to retract the slide member 101d into the cabinet 12, thus accordingly inclining the support column 101c. Then, the CPU 136 drives the air compressor 104 so as to supply air through the hose 106 to the air cushions 103a and 103b (A5). Thereby, the air cushions 103a and 103b are inflated.

After A5, the CPU 136 determines, based on a pressure detection signal from the chair pressure sensor 102, whether a player has left the chair 101 or not (A6). When a player has not left the chair 101 (A6: NO), the processing repeats A6. As long as a player is sitting on the chair 101 and playing a game, the chair pressure sensor 102 keeps sensing pressure given by the player and therefore a pressure detection signal is inputted to the CPU 136. Accordingly, the CPU 136 determines that a player has not left. When a player has left the chair 101 and therefore the chair pressure sensor 102 stops inputting a pressure detection signal (A6: YES), then the CPU 136 determines whether a predetermined period of time (which is 30 minutes in this embodiment) has elapsed after when input of a pressure detection signal stopped, or not (A7).

When a predetermined period of time has not elapsed yet (A7: NO), the processing returns to A6, in which the CPU 136 again determines whether a player has left the chair 101 or not. In a case where, for example, a player has left the chair 101 for a shorter period of time than the predetermined one in order to go to a restroom, etc., the CPU 136 determines NO in A7 because the player comes back to sit on the chair 101 before a predetermined period of time elapses-since the CPU 136 determined that a player had left the chair 101 (A6: YES). Therefore, the CPU 136 keeps the chair 101 in the sitting position.

When a predetermined period of time has elapsed (A7: YES), the CPU 136 drives the air compressor 104 so as to discharge air from the air cushions 103a and 103b through the hose 106 (A8). The air cushions 103a and 103b are deflated accordingly. After A8, the CPU 136 moves the chair 101 to the protecting position as shown in FIG. 6 (A9). More specifically, the CPU 136 drives the motor drive unit 105 so as to advance the slide member 101d to the front of the cabinet 12, thereby making the support column 101c stand up. At this time, the backrest 101b of the chair 101 covers a front side of the liquid crystal display 30. While the slot machine 10 is idle, the chair 101 is held in the protecting position and the backrest 101b of the chair 101 keeps protecting the liquid crystal display 30. After A9, the CPU 136 returns the processing to A2.

While a player is using the slot machine 10, the controller 100 controls the liquid crystal display 30 and the sub display 4 so as to display effect images thereon. During suspension of a game for example, the CPU 136 makes the liquid crystal display 30 display a demo screen, and makes the sub display 4 display an image that illustrates game contents playable in the slot machine 10. During a game, the CPU 136 makes the liquid crystal display 30 display an effect image, and makes the sub display 4 display a payout table and the like. The CPU 136 also produces an effect sound through the speakers 21L and 21R, either simultaneously with or independently of the effect image made on the liquid crystal display 30 or the sub display 4.

In the slot machine 10 of this embodiment, as thus far described above, while a game is being played the chair 101 is placed in the sitting position (see FIG. 1) to enable a player to sit on the seat 101a, and while the slot machine 10 is idle the chair 101 is placed in the protecting position (see FIG. 6) to make the backrest 101b protect the liquid crystal display 30 by covering the front side of the liquid crystal display 30. As a consequence, while the slot machine 10 is idle, the slot machine 10 can be compact to widen a passage, and moreover the liquid crystal display 30 can be protected from a player's attack out of rage about losing a game, etc.

When the chair pressure sensor 102 senses no pressure for a predetermined period of time (A7: YES), the CPU 136 determines that no one is playing a game on this slot machine 10, and drives the motor drive unit 105 so as to move the slide member 101d thereby moving the chair 101 from the sitting position to the protecting position (A9). In this case, the slot machine 10 can be compact to widen a passage and at the same time the liquid crystal display 30 can be protected, as compared with in a case where a hall staff, etc. moves by hand the chair 101 from the sitting position to the protecting position, more surely and more quickly without placing a burden on a hall staff.

The air cushions 103a and 103b are provided on the seat 101a and the backrest 101b of the chair 101 in such a manner that the air cushions 103a and 103b are in contact with a player who is sitting on the chair 101. The air cushions 103a and 103b are supplied with air and inflated, to make the chair 101 comfortable for a player to sit on.

Based on movement of the chair 101 from the protecting position to the sitting position, the CPU 136 drives the air compressor 104 to supply air to the air cushions 103a and 103b (A5). Based on movement of the chair 101 from the sitting position to the protecting position, the CPU 136 drives the air compressor 104 to discharge air from the air cushions 103a and 103b (A8). Accordingly, when the chair 101 is in the sitting position, the air cushions 103a and 103b, which have been supplied with air and inflated, surely make the chair 101 comfortable for a player to sit on. When the chair 101 is in the protecting position, the air cushions 103a and 103b have been deflated because air was discharged therefrom. This brings the backrest 101b of the chair 101 closer to the liquid crystal display 30, as compared with when the air cushions 103a and 103b remain inflated. Therefore, the slot machine 10 can be compact all the more, to widen a passage all the more.

In a case where a water cushion filled with liquid, which is heavier than air, is employed instead of the air cushions 103a and 103b, when the chair 101 is moved from the sitting position to the protecting position under a condition that the liquid has not been discharged from the water cushion, balance of the slot machine 10 as a whole becomes unstable because the chair 101 is too heavy due to the weight of liquid within the cushion. Therefore, there is a high possibility that the slot machine 10 may fall down. However, by discharging the liquid from the water cushion based on movement of the chair 101 from the sitting position to the protecting position in the same manner as described above, the chair 101 is lightened so that balance of the slot machine 10 as a whole is stabilized. Moreover, since the chair 101 is lightened, a load on the motor drive unit 105 is reduced. Consequently, even though a movement means such as the motor does not have so large-scale construction, the chair 101 can easily be moved from the sitting position to the protecting position.

The damper 107 made of an elastic material is provided on the upper edge of the backrest 101b, which is a part of the backrest 101b coming into contact with the liquid crystal display 30 at the time when the chair 101 is placed in the protecting position. As shown in FIG. 6, at the time when the chair is placed in the protecting position, the damper 107 absorbs impact caused upon a collision between the backrest 101b and the liquid crystal display 30. This can more surely prevent damage to the liquid crystal display 30.

In the above-described embodiment, the chair 101 has the seat 101a, the backrest 101b, the support column 101c, and the slide member 101d. However, this is not limitative. Any chair which during a game is usable for a player to sit on and which during an idle is capable of protecting the liquid crystal display 30 as well as widening a passage serves well as the chair according to the present invention.

In the above-described embodiment, after the chair 101 is moved from the protecting position to the sitting position, air is supplied to the air cushions 103a and 103b (see A4 and A5 in FIG. 11). However, it may be possible that air is supplied to the air cushions 103a and 103b during movement of the chair 101 from the protecting position to the sitting position. Alternatively, it may also be possible that, after air is supplied to the air cushions 103a and 103b, the chair 101 is moved from the protecting position to the sitting position.

In the above-described embodiment, after air is discharged from the air cushions 103a and 103b, the chair 101 is moved from the sitting position to the protecting position (see A8 and A9 in FIG. 11). However, it may be possible that air is discharged from the air cushions 103a and 103b during movement of the chair 101 from the sitting position to the protecting position. Alternatively, it may also be possible that, after the chair 101 is moved from the sitting position to the protecting position, air is discharged from the air cushions 103a and 103b.

An armrest, a canned-juice holder, or the like may be mounted on the chair 101.

A design of the chair 101 is not limited to the illustrated one, but may be changed properly.

The gaming machine according to the present invention may further include at least one of a game-value giving means, a winning-combination determination means, a winning-mode display control means, an effect-display control means, a prenotice-display control means, and an accumulated-specific-combination selection means. The game-value giving means gives a player a game value, when a predetermined game result has been displayed. The winning-combination determination means determines a winning combination based on a game-starting signal. The winning-mode display control means makes a winning-mode display means display a winning mode based on a winning combination determined by the winning-combination determination means. The effect-display control means makes an effect-display means display an effect image concerning a game. The prenotice-display control means makes a prenotice-display means display an image indicating that a specific game result will be displayed, before a game-result display means displays the specific game result. The accumulated-specific-combination selection means selects a specific combination, which has been accumulatively stored in a specific-combination accumulation means, as a winning combination.

The game-result display means may include the winning-mode display means, the effect-display means, a notice-display means, and the like. These display means may be provided separately from one another, or may be provided in a single display portion such as one including a sprite circuit, etc., or one for displaying 3-D objects having different depths that is provided in a single display device. Alternatively, an overlap display may also be adopted. Information may be given to a player through one or more, even all, of sense media including, for example, sound, light, color, image, scent, vibration, pressure, etc.

The game-value giving means may include a program for giving a game value, an advantageous-state generation means, or the like. The game-value giving means may carry out payout of a game medium, recording on a magnetic card, addition of a game score, or the like.

The winning-mode display control means, the effect-display control means, and a notice-display control means may be provided either on separate substrates or on a single substrate. The winning-mode display control means and the winning-combination determination means may be provided either on separate substrates or on the same substrate. A substrate on which the effect-display control means and the notice-display control means are formed may be either separate from or the same as a substrate on which the winning-combination determination means is formed.

The winning-mode display means may display a still image, a moving image, and the like. The winning-mode display means includes, for example, one or more symbol display portions that variably display and stop different kinds of symbols painted on reels or disks. However, the winning-mode display means is not limited thereto, as long as it can display a specific winning mode as a game result.

It may be possible that a display-stopping command means outputs a display-stopping signal to one or more, even all, of the effect-display means, the winning-mode display means, and the notice-display means. It may be possible to provide one display-stopping command means with respect to one or more display portions including the symbol display portion. Alternatively, it may also be possible to provide two or more display-stopping command means with respect to one display portion.

The advantageous-state generation means may be a program or the like that executes processings for determination of generation, determination of continuation, determination of premature ending, generation, continuation, ending, etc. However, the advantageous-state generation means is not limited thereto, as long as it keeps a player in an advantageous state during two or more unit games. The winning-combination determination means may include a winning-combination lottery means, a winning-combination carryover means, the specific-combination accumulation means, the accumulated-specific-combination selection means, and the like.

The gaming machine according to the present invention may include a slot machine, a pachi-slot machine, a video slot machine, and the like. A game result may include a winning mode, a losing mode, an effect mode, a notice mode, and the like. The specific winning mode may include displaying a specific symbol (such as “3”, “7”, etc.), displaying a specific combination of symbols (such as “777”, “776”, etc.), displaying a specific symbol and other symbols, and the like.

The losing mode may include modes other than the winning mode which is displayed by the winning-mode display means, the effect mode, the notice mode, and the like. The predetermined game result may include the winning mode and the like. The effect mode may include modes for adding excitement during waiting for a player, during a game, between games, before winning, during winning, after winning, before an advantageous state, during an advantageous state, after an advantageous state or the like, for an announcement of game information, and any other modes. The effect mode may include letters such as “bonus”, “losing”, a numerical character indicating the number of games playable in an advantageous state, and the like.

The image displayed on the prenotice-display means may include an image for giving a player a prenotice of a possibility that a predetermined winning combination is determined, an image for giving a player a prenotice of losing, an image of the effect mode therefor, and the like, or may include letters such as “losing?”, “win bonus?”, and the like. The notice mode may include a mode for giving a player a notice that a predetermined winning combination is determined, a mode for giving a player a notice that a predetermined winning combination is not determined, the effect mode therefor, and the like, or may include letters such as “bonus determined”, “losing determined”, and the like.

The mode such as the winning mode, the losing mode, the effect mode, and the notice mode may include a moving or still image of one or more symbols, a moving or still image of one or more characters, a moving or still image of one or more backgrounds, a moving or still image of one or more speech balloons, one or more letters, one or more figures, a predetermined motion of one or more movable objects, lighting and flashing of one or more lamps, a sound from one or more speakers, or the like. The game information may include a game concept, game rules, an operation manual, explanations for winning combinations and replaying, explanations for an advantageous state such as a bonus game, a probability of getting an advantageous state, the number of games finished since a predetermined time point such as since a bonus game started, since a predetermined operation was made, etc., and the like.

The game-starting signal may be outputted in response to operation of a start lever, press of a spin button, insertion of a game medium, placement of symbols into initial positions, and the like. The display-stopping command means may include a button, a lever, a program acting as a clock means, and the like. The symbol display portion may be a CRT, a liquid crystal display, a plasma display, a 7-segment, a dot matrix, a lamp, an LED, a fluorescent lamp, an EL (electroluminescence), an electronic paper, a flexible LED, a flexible liquid crystal, a liquid crystal projector, a reel, a disk, a movable object, or the like. The symbol display portion may also be a combination thereof.

The winning combination may include one or more combinations that have been selected from several combinations by the winning-combination determination means. The game value may include paying out a game medium, writing into a game-result memory medium such as a magnetic card, replaying, adding a score, generating an advantageous state, or the like. The game medium may include a coin, a medal, a gaming ball, a currency, a banknote, a magnetic card, and the like.

In the slot machine or the like, it may be possible to adopt, as a win, one or more of a bonus game which is different from the bonus game of the above-described embodiment, a mystery bonus game, a winning combination prenotification, and a replay. In the bonus game, a player is given a game value that is equivalent to points the player has acquired in a sub game which is different from a base game. In the mystery bonus game, a game value which will be paid out for a unit game is determined by multiplying the number, of inserted game media by a predetermined magnification factor. The winning combination prenotification is for, in response to a player's operation on the display-stopping command means, providing the player with information about a winning combination that has been determined by the winning-combination determination means. The replay enables a player to start next one unit game without inserting an additional game medium.

The one unit game may be defined by any one of periods: from outputting a game-starting signal to displaying a game result; from operating a start lever to displaying a game result on a display means; from operating a start lever to displaying specific display contents such as specific literal information, a specific character, or a specific image on a predetermined display means; from pressing a BET button or inserting a game medium to displaying a game result on a display means, in a case where a game-starting signal is outputted at the time when a player presses a BET button or inserts a game medium; from pressing a BET button or inserting a game medium to displaying specific display contents on a display means, in a case where a game-starting signal is outputted at the time when a player presses a BET button or inserts a game medium; from sensing insertion of a game medium such as a gaming ball to displaying a game result on a display means; from sensing insertion of a game medium to displaying specific display contents on a display means. As the two or more unit games, a multiple times of unit games, either continuously or intermittently, may be applied.

The present invention is applicable not only to actual machines such as the above-described slot machine 10, a pachi-slot machine, a pinball game machine, etc., but also to a game program for virtually executing operation, which would be done in the actual machine, in a home gaming machine or the like. In this case, as a record medium in which the game program is stored, a DVD-ROM, a CD-ROM, an FD (flexible disk), and any other arbitrary record media may be used.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims.

What is claimed is:

1. A gaming machine comprising:
a display unit for displaying game information;
a chair that includes a seat and a backrest;
a guide unit that is connected to the chair and capable of placing the chair in a sitting position which enables a player to sit on the seat and in a protecting position which makes the backrest protect the display unit by covering a front side of the display unit.

2. The gaming machine according to claim 1, wherein the gaming machine further comprises:
a sensor that is provided to the seat; and
a movement unit for operating the guide unit so as to move the chair from the sitting position to the protecting position, when the sensor senses nothing for a predetermined period of time.

3. The gaming machine according to claim 1, wherein the seat and the backrest have, at their portions that come into contact with a player who is sitting on the chair, spaces capable of being filled with fluid.

4. The gaming machine according to claim 3, wherein the gaming machine further comprises a fluid control unit for supplying fluid to the spaces based on movement of the chair from the protecting position to the sitting position and discharging fluid from the spaces based on movement of the chair from the sitting position to the protecting position.

5. The gaming machine according to claim 1, wherein an elastic member is provided in such a portion of the backrest that comes into contact with the display unit at the time when the chair is placed in the protecting position.
